(19) United States
(12) Patent Application Publication
(10) Pub. No.: US 2008/0190711 A1
(43) Pub. Date: Aug. 14, 2008

(54) Elevator Cab Ceiling with Dissipative Ventilation Channel

(76) Inventors: William P. Patrick, Glastonbury, CT (US); Qinqian Zeng, Manchester, CT (US)

Correspondence Address: Kerrie A. laba;Carlson, Gaskey & Olds, 400 W. Maple Road, Suite 350, Birmingham, MI, 48009, US

(21) Appl. No.: 11/631,132

(22) PCT Filed: Jun. 30, 2004
(86) PCT No.: PCT/US04/21258

§ 371 Date: Dec. 28, 2006

(51) Int. Cl. B66B 11/02; G10K 11/16

(52) U.S. Cl. 187/401; 181/296

(57) ABSTRACT

An elevator cab ceiling (22) includes an upper ceiling panel (26), a lower ceiling panel (28), and a ventilation channel (30) extending between the upper ceiling panel (26) and the lower ceiling panel (28). The ventilation channel (30) extends at an oblique angle relative to the upper ceiling panel (26) and separates space between the upper (26) and lower (28) ceiling panels into an upper cavity (32) and a lower cavity (34). A plurality of partitions (36) are formed within at least one of the upper (32) or lower (34) cavities. In one example, an acoustically resistive element (42) extends at least partially along a portion of the ventilation channel (30). The plurality of partitions (36) and the acoustically resistive element (42) cooperate to reduce noise levels transmitted into an elevator cab (10) via the ventilation channel (30).

### FIELD OF THE INVENTION

This invention generally relates to elevator systems. More particularly, this invention relates to an elevator cab ceiling having a sound absorbing ventilation channel.

### DESCRIPTION OF THE RELEVANT ART

An elevator cab ceiling typically includes a ventilation duct or channel that allows airflow between an elevator cab and a hoistway. A ventilation fan facilitates airflow within the ventilation channel. Traditionally, the ventilation channel is formed as a vertical duct that extends straight through the ceiling. Typically, the ventilation channel extends straight down from an upper opening at a top portion of the elevator cab to a lower opening in the ceiling within the elevator cab.

An elevator machine drives a rope system to move the elevator cab within a hoistway. During elevator operation, noise from the elevator machine, hoistway, rope radiation, and the ventilation fan can be easily transmitted into the elevator cab. This noise can disturb a passenger. The ventilation channel in the elevator ceiling is one of the main noise transmission paths. The generally vertical orientation of the ventilation channel provides a direct noise path into the elevator cab.

There is a need for an improved ventilation arrangement. Disclosed embodiments of this invention utilize a double ceiling with an angled ventilation channel having one or more acoustically absorbing walls to dissipate noise, which avoid the difficulties mentioned above.

### SUMMARY OF THE INVENTION

In general terms, this invention is an elevator cab ceiling that includes a sound absorber to reduce noise levels and improve ride quality. An example ceiling includes an upper ceiling panel and a lower ceiling panel spaced apart from each other. A ventilation channel extends between the upper ceiling panel and the lower ceiling panel. The sound absorber is positioned between the upper and lower ceiling panels. The sound absorber reduces noise transmission into an elevator cab through the ventilation channel.

In one example, an upper cavity is formed between the ventilation channel and the upper ceiling panel and a lower cavity is formed between the ventilation channel and the lower ceiling panel. A plurality of partitions is formed within at least one of the upper or lower cavities. Each partition is formed as a partition wall that is spaced apart from an adjacent partition wall to form a plurality of sub-cavities. Each sub-cavity is tuned to a predetermined resonant frequency.

In one example, an acoustically resistive element is used to cover at least a portion of the ventilation channel. The acoustically resistive element can be a screen, perforated plate, microperforated sheet, or any other similar element known in the art. The acoustically resistive element can be placed along the entire length of the ventilation channel or along only portions of the length. Further, the acoustically resistive element can be used to cover an upper wall portion, a bottom wall portion of the ventilation channel or both. By selecting a proper material for the acoustically resistive element, a maximum acoustic absorption coefficient can be achieved at a resonant frequency, which leads to a large transmission loss at this frequency. In one example, each sub-cavity has a different resonant frequency, such that a series of cavities provide broad attenuation for noise.

The elevator cab ceiling includes a ventilation channel and a sound absorber that improves ride quality by reducing undesirable noise transmission into an elevator cab. The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a perspective view of an elevator cab that has a double ceiling designed according to an embodiment of this invention.

FIG. 2A schematically illustrates one example of a side cross-sectional view, partially broken away, of the double ceiling of FIG. 1.

FIG. 2B is a partial cross-section taken along line 2B of Figure A.

FIG. 3 schematically illustrates another example of a side cross-sectional view, partially broken away, of the double ceiling of FIG. 1.

FIG. 4 schematically illustrates another example of a side cross-sectional view, partially broken away, of the double ceiling of FIG. 1.

FIG. 5 is a graph of transmission loss vs. frequency.

FIG. 6 schematically illustrates a perspective view of another example of an elevator cab that has a double ceiling.

### DETAILED DESCRIPTION OF THE PREFERRED EMBODIMENTS

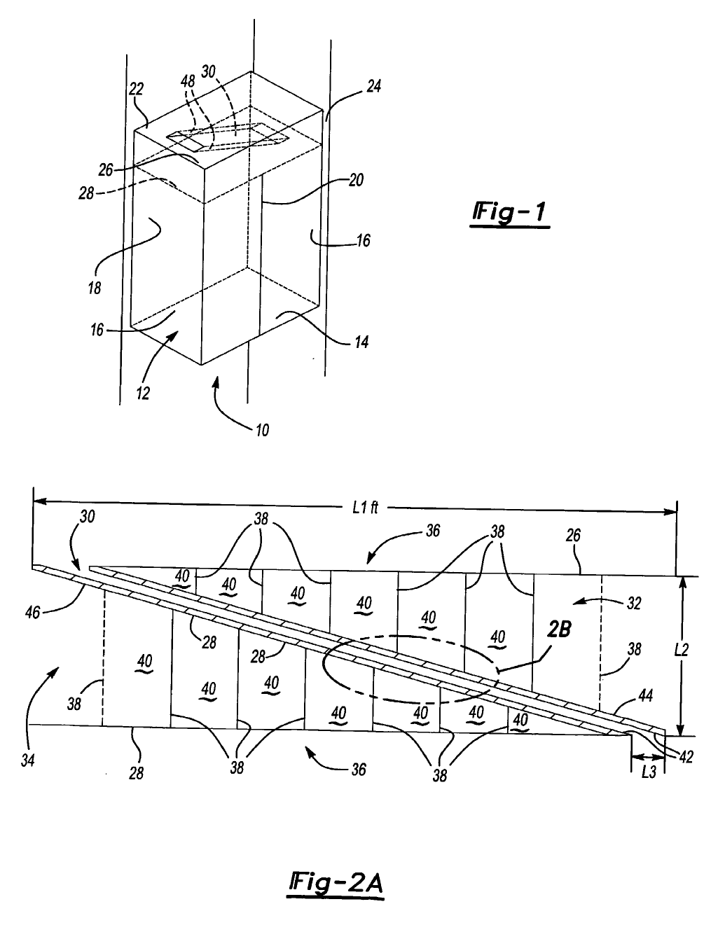

As seen in FIG. 1, an elevator cab 10 includes a passenger compartment 12 defined by a floor 14, a pair of side walls 16, a back wall 18, a pair of elevator doors 20, and a ceiling 22. An elevator machine (not shown) is used to move the elevator cab 10 within an elevator hoistway 24.

The ceiling 22 includes a first ceiling panel 26 and a second ceiling panel 28. The first and second ceiling panels 26 and 28 are spaced apart from each other and are positioned in an overlapping relationship. An air duct or ventilation channel 30 extends between the first and second ceiling panels 26 and 28. In one example, the ventilation channel 30 extends from the first ceiling panel 26 to the second ceiling panel 28 at least partially at an oblique angle relative to the first ceiling panel 26. It should be understood that while the ventilation channel 30 is shown as being generally straight, the ventilation channel 30 could be curved to accommodate lighting fixtures or other components (not shown) housed within the ceiling 22. The ventilation channel 30 may have a variety of cross-sectional configurations.

As shown in FIG. 2A, a first cavity 32 is formed between the ventilation channel 30 and the first ceiling panel 26 and a second cavity 34 is formed between the ventilation channel 30 and the second ceiling panel 28. A sound absorber is positioned within the ceiling 22 in at least one of the first and second cavities 32 and 34. The sound absorber is used to reduce noise transmitted through the ventilation channel 30 into the elevator cab 10.

In one example, the sound absorber includes a plurality of partitions, indicated generally at 36, formed within the first and second cavities 32 and 34. In this example, each partition 36 is formed as a partition wall 38 that extends from the ventilation channel 30 to the respective ceiling panel. The partition walls 38 have a generally solid surface. Further, the ventilation channel 30 can be defined by a continuous surface, discontinuous surface with openings to the partitions 36, or can be formed as a combination of continuous and discontinuous surfaces.

The partition walls 38 form a plurality of sub-cavities 40 within the first and second cavities 32 and 34, respectively. Each sub-cavity 40 is tuned to a certain predetermined resonant frequency because of its shape, size or both. The width of the ventilation channel 30 can also be varied to tune the resonant frequency for each sub-cavity 40. In one example, each subcavity resonant frequency is different from every other resonant frequency. In other words, each sub-cavity 40 is tuned to a unique resonant frequency.

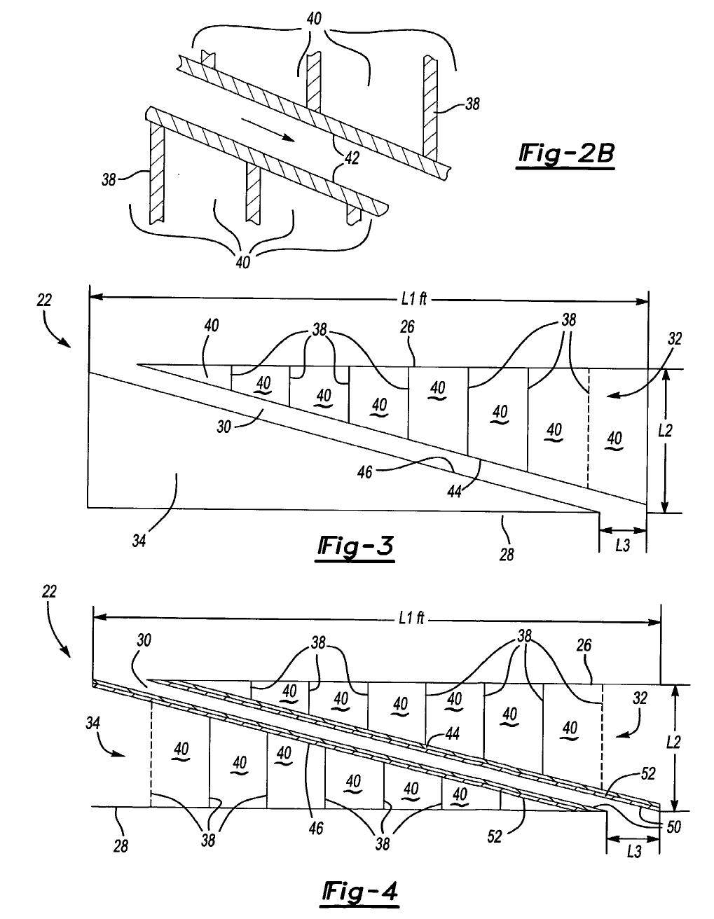

In the example of FIG. 3, the sound absorber includes an acoustically resistive element 42 that covers at least a portion of the ventilation channel 30 to provide additional sound absorption. The acoustically resistive element 42 can be a resistive screen, perforated plate, microperforated sheet, or any other similar element known in the art. A resistive screen can be any type of a porous sheet of material, such as a porous aluminum sheet of material, for example. A perforated plate can be formed from any type of material known in the art including stainless steel or aluminum, for example. A microperforated sheet can be made from any type of material known in the art including stretched PVC (polycarbonate) foil, for example.

The acoustically resistive element 42 can be placed along the entire length of the ventilation channel 30 or along only portions of the length. Further, the acoustically resistive element 42 can be used to cover an upper wall portion 44, a lower wall portion 46 of the ventilation channel 30 or both. In the example shown in FIG. 2A, the acoustically resistive element 42 covers both. Further, as shown in FIG. 2B, the acoustically resistive element 42 covers the ventilation channel 30 having an at least partially discontinuous surface. Those skilled in the art who have the benefit of this description will be able to design an arrangement to meet their particular needs.

Side wall portions 48 (see FIG. 1) of the ventilation channel 30 preferably are rigid. However, in any of the described examples, the side wall portions 48 can also be covered with an acoustically resistive element 42. This provides additional noise attenuation as needed.

By selecting the proper material with a proper flow resistance for the acoustically resistive element 42, the acoustic absorption coefficient at selected resonant frequency (or set of frequencies) can be maximized, which leads to a large transmission loss at that frequency (or set of frequencies). Further, as each sub-cavity 40 has a different or unique resonant frequency, the series of sub-cavities 40 provides a broad noise attenuation range.

Spacings between each adjacent partition walls 38 preferably are not larger than one-eighth (⅛) of the smallest wavelength in the desired frequency range. For example, assume the desired frequency range is 0-1000 Hertz (Hz) with the minimum wavelength at 1000 Hz in air at normal condition being 0.34 meters (m). Under these conditions, the largest desired spacing would be 4.3 centimeters (cm).

If less noise attenuation is required, it may not be necessary to form sub-cavities 40 within the second cavity 34. One such example configuration is shown in FIG. 3. In this configuration, the lower wall portion 46 of the ventilation channel 30 is formed as a continuous unbroken surface with no sub-cavities 40. In other words, the lower wall portion 46 is not interrupted to establish any sub-cavities 40. This example provides noise attenuation through the sub-cavities 40 in the first cavity 32 and the acoustically resistive element 42 along the upper wall portion 44, while providing additional space to accommodate lighting fixtures (not shown) within the second cavity 34.

In one example, the acoustically resistive element 42 is comprised of multiple members. As shown in FIG. 4, a resistive screen 50 can be combined with a perforated plate 52 to lower the resonant frequency. This combination also provides higher flow resistance. In the example shown, the perforated plate 52 is positioned between the lower wall portion 46 and the resistive screen 50, however, it should be understood that the position of the resistive screen 50 and the perforated plate 52 could be switched. It should be understood that the acoustically resistive element 42 could include one or more of a resistive screen 50, perforated plate 52, or other similar component. Further, the acoustically resistive element 42 can be used alone or in combination with the partitions 36 to reduce noise.

In one example, the acoustically resistive element is formed from an ALMUTE or POAL material. Both materials are commercially available from PEER Company. The materials provide broadband sound absorption, are non-corrosive, non-flammable, and can be used in harsh environments.

ALMUTE is a non-fibrous, sintered metal material that does not release airborne particles. Further, ALMUTE lasts longer without deteriorating or causing environmental pollution, which is a significant advantage over a material such as fiberglass. POAL material is lightweight and easy to cut and handle, and thus also offers advantages over fiberglass materials. While ALMUTE and POAL are two examples of materials that could be used, it should be understood that other known sound-absorbing materials could also be used to form the acoustically resistive element 42.

As discussed above, the ventilation channel 30 does not have to extend along a straight path. Additionally, in one example shown in FIG. 6, side walls 56 of at least one of cavities 32 or 34 extend at an oblique angle relative to the associated ceiling panel. In this example, the sub-cavities 40 are wider at an end 60 away from the lower wall portion 46 of the ventilation channel 30. This provides the sub-cavities 40 with more volume, which lowers the resonant frequency of each respective sub-cavity 40. Decreasing the volume by using an opposite configuration can be done if the resonant frequencies need to be increased.

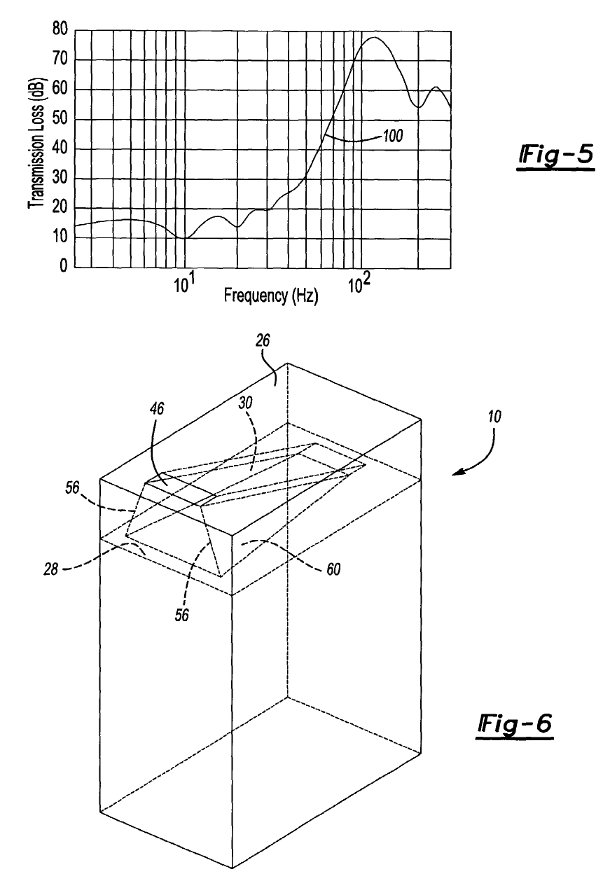

FIG. 5 shows the amount of noise reduction that would occur for any given frequency within the desired range for a ceiling 22 incorporating a ventilation channel 30 designed according to an embodiment of this invention. For example, assume that the length of the first and second ceiling panels 26 and 28 is designated as L1, the height between the first and second ceiling panels 26 and 28 is designated as L2, and the width of the opening of the ventilation channel 30 is designated as L3 (FIGS. 2A or 3). Further, assume L1=4 feet, L2=6 inches, and L3=0.171 feet, and ALMUTE or POAL material is used for the acoustically resistive element 42. Both materials have a normalized flow resistance of approximately 1 in air. Further, assume each of the first 32 and second 34 cavities is divided into ten sub-cavities 40. Along each sub-cavity 40, the width of the ventilation channel 30 is 0.241 meters, the height of the ventilation channel 30 is 0.0521 meters, and the length of the ventilation channel 30 is 0.1219 meters.

The calculated transmission loss through the ventilation channel 30 is plotted at 100 in FIG. 5. This transmission loss includes reactive and dissipative effects. The reactive effect is contributed to by the area reduction between the elevator hoistway 24 and ventilation channel 30, and the area expansion between the ventilation channel 30 and the elevator cab's 10 cross-sectional area. The cross-sectional area of the elevator cab 10 is 1.048 meters by 1.449 meters in this example. As shown in FIG. 6, this provides a noise reduction of 10 decibels at 100 Hertz and a noise reduction of 75 decibels at 1000 Hertz.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An elevator ceiling (22) comprising:
first panel (26);
a second panel (28) spaced apart from said first panel (26);
a ventilation channel (30) extending at least partially at an oblique angle between said first panel (26) and said second panel (28): and
a first cavity formed between said ventilation channel (30) and said first panel (26) and a second cavity formed between said ventilation channel (30) and said second panel (28).

2. The elevator ceiling (22) of claim 1, including a sound absorber positioned between said first (26) and second (28) panels for reducing noise transmission through said ventilation channel (30).

3. The elevator ceiling (22) of claim 2, wherein said sound absorber comprises an acoustically resistive element (42) extending at least partially along said ventilation channel (30).

4. The elevator ceiling (22) of claim 3, wherein said acoustically resistive element (42) comprises a screen (50).

5. The elevator ceiling (22) of claim 4, wherein said screen (50) comprises a porous metallic sheet.

6. The elevator ceiling (22) of claim 3, wherein said acoustically resistive element (42) comprises a perforated plate (52).

7. The elevator ceiling (22) of claim 3, wherein said resistive element (42) comprises a microperforated sheet.

8. The elevator ceiling (22) of claim 3, wherein said acoustically resistive element (42) comprises a screen (50) and a perforated plate (52) positioned in an overlapping relationship with each other.

9. The elevator ceiling (22) of claim 2, wherein said sound absorber includes a plurality of partitions (36) formed between said ventilation channel (30) and at least one of said first (26) and second (28) panels wherein each partition (36) is formed as a partition wall (38) spaced apart from an adjacent partition wall (38) to form a plurality of cavities (40) with each cavity (40) being tuned to a predetermined resonant frequency.

10. The elevator ceiling (22) of claim 9, wherein said plurality of partitions (36) comprises a first set of partitions formed between said first panel (26) and said ventilation channel (30) and a second set of partitions formed between said second panel (28) and said ventilation channel (30).

11. The elevator ceiling (22) of claim 9, wherein said ventilation channel (30) includes an upper wall portion (44) and a lower wall portion (46).

12. The elevator ceiling (22) of claim 11, wherein said sound absorber has an acoustically resistive element (42) extending at least partially along at least one of said upper (44) and lower (46) wall portions.

13. An elevator ceiling (22) comprising:
an upper ceiling panel (26);
a lower ceiling panel (28) spaced apart from and positioned in an overlapping relationship to said upper ceiling panel (26);
a ventilation channel (30) extending from said upper ceiling panel (26) to said lower ceiling panel (28); and
a sound absorber positioned between said upper (26) and lower (28) ceiling panels for reducing noise transmission through said ventilation channel (30).

14. The elevator ceiling (22) of claim 13, including a first cavity (32) formed between said ventilation channel (30) and said upper ceiling panel (26), and a second cavity (34) formed between said ventilation channel (30) and said lower ceiling panel (28) wherein said sound absorber includes a plurality of partitions (36) formed within at least one of said first (32) and second (34) cavities.

15. The elevator ceiling (22) of claim 14, wherein said plurality of partitions (36) are formed as a plurality of partition walls (38) generally parallel to and spaced apart from each other in a direction extending along a length of the ventilation channel (30) to form a plurality of sub-cavities (40) with each sub-cavity (40) being tuned to a predetermined resonant frequency.

16. The elevator ceiling (22) of claim 14, wherein said ventilation channel (30) includes angled side walls (56) extending at least partially at an oblique angle relative to at least one of said upper (26) and lower (28) ceiling panels.

17. The elevator ceiling (22) of claim 14, wherein said plurality of partitions (36) comprises a first set of partitions formed within said first cavity (32) and a second set of partitions formed within said second cavity (34).

18. The elevator (22) of claim 14, wherein said ventilation channel (30) extends at least partially at an oblique angle between said upper ceiling panel (26) and said lower ceiling panel (28).

19. The elevator ceiling (22) of claim 18, wherein said ventilation channel (30) includes an upper wall portion (44) and a lower wall portion (46) and wherein an acoustically resistive element (42) extends at least partially along at least one of said upper (44) and lower (46) wall portions.

20. A method for reducing noise transmission through a ventilation channel (30) in an elevator ceiling (22) comprising:
positioning a sound absorber at least partially along a ventilation channel (30) that is between an upper ceiling panel (26) and a lower ceiling panel (28) to thereby reduce noise transmitted through the ventilation channel (30).

21. The method of claim 20, wherein formation of the sound absorber includes positioning a plurality of partitions (36) between the ventilation channel (30) and at least one of the upper (26) and lower (28) ceiling panels; and
forming each partition (36) as a partition wall (38), spacing each partition wall (38) apart from an adjacent partition wall (38) to form a plurality of cavities (40), each cavity (40) being tuned to a predetermined resonant frequency.

22. The method of claim 20, wherein formation of the sound absorber includes extending an acoustically resistive element (42) at least partially along the ventilation channel (30).

23. The method of claim 20, including positioning at least a portion of the ventilation channel (30) at an oblique angle relative to one of the upper and lower ceiling panels (26, 28).

24. The elevator ceiling (22) of claim 1, wherein a sound absorber is positioned within the elevator ceiling in at least one of the first and second cavities.

25. The method of claim 20, including forming a first cavity between the ventilation channel (30) and the upper ceiling panel (26) and forming a second cavity between the ventilation channel (30) and the lower ceiling panel (28).
